(19) United States
(12) Patent Application Publication
(10) Pub. No.: US 2026/0191740 A1
(43) Pub. Date: Jul. 9, 2026

(54) Automated Liquid Medicine Transfer Apparatus Using a Syringe

(71) Applicant: SEOUL NATIONAL UNIVERSITY HOSPITAL, Seoul (KR)

(72) Inventors: Young Bong BANG, Seoul (KR); Yoon Sook CHO, Gyeonggi-do (KR); Seong Ho KONG, Seoul (KR); Joanne YOON, Seoul (KR); Ye Lin KIM, Seoul (KR); Rae Hun JUNG, Seoul (KR); Sa Ram LEE, Gyeonggi-do (KR)

(21) Appl. No.: 19/132,628

(22) PCT Filed: Nov. 7, 2023
(86) PCT No.: PCT/KR2023/017748

§ 371 Date: May 23, 2025

(30) Foreign Application Priority Data
Nov. 23, 2022 (KR) 10-2022-0158439

(51) Int. Cl. A61J 1/20; A61J 1/16

(52) U.S. Cl. CPC A61J 1/20; A61J 1/16

(57) ABSTRACT

The present disclosure relates to an apparatus that automates the transfer of liquid medicine between containers using a syringe, and is characterized by including a housing, a syringe automation unit, a liquid medicine container transfer automation unit, and a control unit.

### TECHNICAL FIELD

The present disclosure relates to an apparatus for automated liquid medicine transfer. More particularly, it relates to a device that automates the transfer of a predetermined amount of liquid medicine between medicine vials or intravenous (IV) bags using a syringe.

### BACKGROUND ART

The following describes background information relevant to the present disclosure, which is not necessarily prior art.

In general, in the preparation of drugs such as anticancer agents, it is frequently required to extract a desired amount of the drug from a vial using a syringe and inject it into an intravenous (IV) bag or another vial.

When performed manually, this process may result in variation in precision depending on the skill of the preparer. Furthermore, when using syringes with large capacities, significant force is required, making repetitive operation difficult.

Although automated devices have been developed to address these issues, they may be limited in the range of syringe capacities they can accommodate, may lack accuracy in gripping syringes and medicine containers, and may be large and complex in scale. Additionally, the need for consumables other than the syringe itself may result in higher operating costs, presenting further usability challenges. Thus, various improvements are still required.

### DETAILED DESCRIPTION OF INVENTION

### Technical Problem

The present disclosure aims to solve the above-mentioned problems by providing an automated liquid medicine transfer apparatus capable of accurately and stably gripping syringes and medicine containers in proper positions and compatible with various syringe capacities.

### Technical Solution

To achieve the above technical problem, one exemplary embodiment of the present disclosure provides an automated liquid medicine transfer apparatus using a syringe, comprising:
a housing;
a syringe automation unit disposed on one side of the housing, comprising:
   a barrel fixing unit that secures the barrel of an inserted syringe;
   a piston gripping unit that grips the piston of the syringe; and
   a syringe drive unit configured to move the barrel fixing unit and the piston gripping unit relative to each other;
a liquid medicine container transfer automation unit, comprising:
   a first frame disposed at an upper portion of the housing;
   a first gripping unit disposed on one side of the first frame and configured to grip an extraction container containing a liquid medicine to be extracted;
   a second gripping unit disposed on the opposite side of the first frame and configured to grip an injection container into which the extracted liquid medicine is to be injected; and
   a frame transfer unit configured to move the first frame between a first position corresponding to the extraction container and a second position corresponding to the injection container; and
a control unit operably connected to the syringe drive unit and the frame transfer unit, the control unit being configured to:
   pull the piston to extract the liquid medicine when the first frame is in the first position; and
   push the piston to inject the liquid medicine when the first frame is in the second position.

The barrel fixing unit may be configured such that the syringe is inserted and fixed with its needle oriented vertically upward.

In addition, the barrel fixing unit may be configured to fix the handle of the syringe barrel.

The barrel fixing unit may comprise a syringe handle support plate configured to support the lower surface of the syringe handle, a syringe handle pressing plate disposed above the support plate, and a pressing plate drive unit configured to move the syringe handle pressing plate vertically, wherein the syringe inserted between the support plate and the pressing plate is fixed in place.
Alternatively, the barrel fixing unit may include a syringe handle support plate for supporting the upper surface of the syringe handle, a syringe handle pressing plate disposed below the support plate, and a pressing plate drive unit for moving the syringe handle pressing plate vertically, wherein the syringe inserted between the support plate and the pressing plate is fixed in place.

The barrel fixing unit may further include a first gripper disposed above the pressing plate and including a pair of first gripper arms symmetrically positioned and configured to perform an opening and closing operation by moving parallel to each other in opposite directions based on a predefined axis.

Each of the first gripper arms may extend in a direction parallel to the predefined axis.

The gripping surface of the first gripper arms may include a first inclined surface forming a first angle (θ) with respect to the gripper's parallel movement axis, and a second inclined surface forming a second angle (−θ) with respect to the parallel movement axis, wherein the first and second angles may have equal magnitudes and opposite signs.

The gripping surface of each first gripper arm may be curved to accommodate an outer surface of the syringe barrel.

The piston gripping unit may include a first slot having a first width (W1) and a second slot having a second width (W2) and may be connected with an upper portion of the first slot. The unit may support the upper and lower surfaces of the piston handle, and the widths may satisfy the conditions.

W1 may be greater than or equal to the width of the piston handle.

W2 may be greater than or equal to the width of a piston rod and less than the width of the piston handle.

The piston gripping unit may also include a pressing plate insertion hole through a bottom of the piston handle grip frame, a piston handle pressing plate inserted through the hole, and a pressing plate drive unit for vertically moving the pressing plate.

The first and second gripping units may grip the medicine containers such that the inlets face vertically downward.

The first gripping unit may include a second gripper configured to grip a medicine vial, and the second gripping unit may be selected from a group consisting of a third gripper configured to grip an intravenous bag with a cylindrical inlet, a fourth gripper configured to grip an intravenous bag with a polyhedral inlet, or a combination thereof.

The second to fourth grippers may be configured to maintain an open or closed state using a toggle mechanism.

Each of the third and fourth grippers may include at least one gripper tooth on gripping surfaces of respective gripper arms.

A plurality of gripper teeth may be provided in plurality on the gripping surface of each gripper arm, and the plurality of gripper teeth may be vertically spaced apart from one another

Each of the third and fourth grippers may further include an insertion groove on a lower surface thereof, the insertion groove being configured to receive and support the protrusion of an inlet of the intravenous bag.

The frame transfer unit may perform two-axis orthogonal movement.

The first frame may further comprise an intravenous bag holder configured to hold a pouch-type container.

The frame transfer unit may be configured to move the first frame vertically and to rotate the first frame about a vertical axis as the axis of rotation.

Another embodiment of the automated liquid medicine transfer apparatus using a syringe may comprise:
a housing;
a syringe automation unit disposed on one side of the housing, the syringe automation unit comprising:
   a barrel fixing unit configured to fix a syringe barrel inserted therein;
   a piston gripping unit configured to grip a piston of the syringe; and
   a syringe drive unit configured to move the barrel fixing unit and the piston gripping unit relative to each other;
a third gripper provided at a first location around the syringe automation unit and configured to grip an extraction container containing liquid medicine to be extracted;
a fourth gripper provided at a second location around the syringe automation unit and configured to grip an injection container for receiving the extracted liquid medicine;
a syringe transfer unit configured to move the syringe automation unit to a third position corresponding to the extraction container or a fourth position corresponding to the injection container; and
a control unit operably connected to the syringe drive unit and the syringe transfer unit, the control unit being configured to pull the piston to extract the liquid medicine when the syringe automation unit is moved to the third position, and to push the piston to inject the liquid medicine when the syringe automation unit is moved to the fourth position.

The syringe transfer unit may include a rotational movement part configured to rotate the syringe automation unit to face the third position or the fourth position, and a linear movement part configured to move the syringe automation unit forward and backward.

### Effects of Invention

According to the configuration and combination described above, the present disclosure allows for automated, repetitive transfer of a liquid medicine between containers accurately and reliably without the need for significant force.

Moreover, since the syringe and liquid medicine containers can be directly connected and disconnected, no additional consumables are required during operation, making the system cost-effective.

The gripping mechanism also allows for secure holding of syringes and medicine containers of various sizes, offering flexibility.

Additionally, the use of two-axis orthogonal movement reduces space requirements for system design, providing versatility for use in a variety of environments.

### BRIEF DESCRIPTION OF DRAWINGS

FIG. 1 is a perspective view of an automated liquid medicine transfer apparatus using a syringe, according to one embodiment.

FIG. 2 is a perspective view of a barrel fixing unit according to one embodiment.

FIG. 3 is a front view of the barrel fixing unit according to one embodiment.

FIG. 4 is a perspective view of a first gripper according to one embodiment.

FIG. 5 is a cross-sectional view taken along the Y-axis of FIG. 4, showing the first gripper gripping syringe barrels of various capacities according to one embodiment.

FIGS. 6A and 6B are perspective views of a piston gripping unit according to one embodiment.

FIG. 7 is a sectional view taken along the X-axis of FIG. 6A, illustrating the piston gripping unit according to one embodiment.

FIG. 8 is a perspective view of the piston gripping unit and a syringe drive unit according to one embodiment.

FIG. 9 is a perspective view of an automated liquid medicine transfer apparatus according to one embodiment.

FIG. 10 is a diagram of the structure of a second gripper and a toggle spring section of the second gripper according to one embodiment.

FIG. 11 is a perspective view of a second gripping unit according to one embodiment.

FIG. 12 is a perspective view of a portion of a third gripper arm according to one embodiment.

FIG. 13 is a view showing a state in which the third gripper grips an intravenous (IV) bag having a cylindrical inlet according to one embodiment.

FIG. 14 is a perspective view of a portion of a fourth gripper arm according to one embodiment.

FIG. 15 is a view of a state in which the fourth gripper grips an intravenous (IV) bag having a polyhedral inlet according to one embodiment.

FIG. 16 is a perspective view of a frame transfer unit according to one embodiment.

FIG. 17 is a perspective view of an orthogonal movement according to one embodiment.

FIG. 18 is a perspective view of a portion of Modified Embodiment 1.

FIG. 19 is a plan view of a portion of Modified Embodiment 1.

FIG. 20 is a front view of a portion of Modified Embodiment 2.

FIG. 21 is an operational flowchart of Modified Embodiment 2.

### EMBODIMENT FOR IMPLEMENTATION OF INVENTION

Below, exemplary embodiments according to the present disclosure are described in detail with reference to the contents described in the accompanying drawings. The disclosed embodiments can be implemented in various forms.

In each drawing, the same reference numbers or symbols represent components or elements that perform substantially the same functions.

Expressions such as ‘comprise’ or ‘may comprise,’ as used in various embodiments of the present disclosure, indicate the presence of corresponding features, operations, or components disclosed in the disclosure, but do not preclude the presence of one or more additional features, operations, or components. Furthermore, in various embodiments of the present disclosure, terms such as ‘comprise’ or ‘include’ are intended to indicate the presence of features, numbers, steps, operations, components, parts, or combinations thereof as described in the specification, and are not intended to preclude the possibility of the presence or addition of one or more other features, numbers, steps, operations, components, parts, or combinations thereof. Singular expressions are to be interpreted to include plural expressions unless clearly stated otherwise by context.

When a component is described as ‘connected to’ or ‘coupled to’ another component, it may be directly connected or coupled, or there may be one or more other intervening components. Conversely, when a component is described as ‘directly connected to’ or ‘directly coupled to’ another component, it is to be understood that there are no other intervening components.

The terms ‘first,’ ‘second,’ etc., as used herein, may be used to describe various elements, but the elements should not be limited by these terms. These terms are used only to distinguish one element from another. For example, without departing from the scope of the disclosure, a first element may be referred to as a second element, and similarly, a second element may be referred to as a first element.

The term ‘extraction container’ refers to a container in which a liquid medicine to be extracted is stored. The term ‘injection container’ refers to a container into which the liquid medicine is to be injected. The term ‘liquid medicine container’ may refer to either or both of the ‘extraction container’ and the ‘injection container,’ or to cases where it is unnecessary to distinguish between the two.

The terms ‘vertical’ and ‘horizontal,’ as used herein, assume that the automated liquid medicine transfer apparatus using a syringe, according to an embodiment of the disclosure, is installed on a level surface, and these terms are used to describe orientation relative to the ground.

Hereinafter, preferred embodiments of the present disclosure will be described in detail with reference to the drawings.

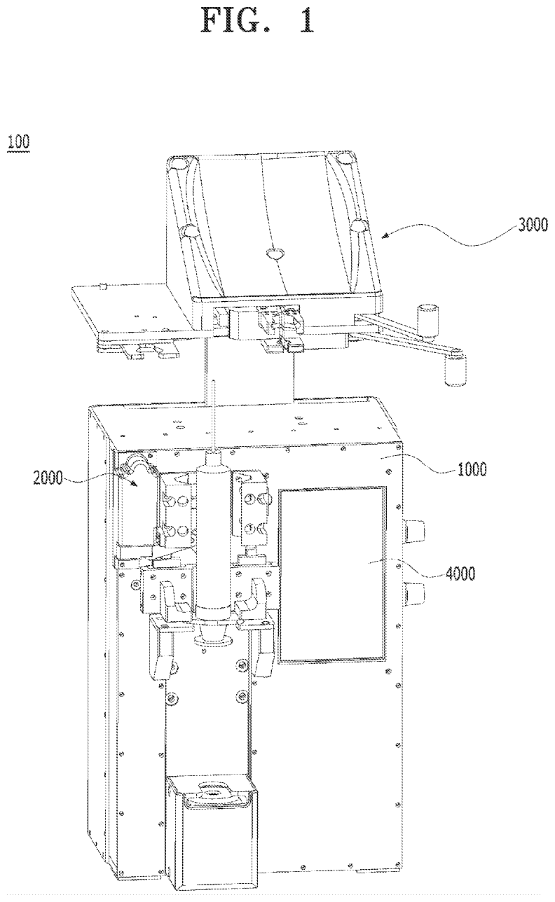

FIG. 1 is a perspective view of an automated liquid medicine transfer apparatus using a syringe according to one embodiment.

Referring to FIG. 1, the automated liquid medicine transfer apparatus (100) using a syringe according to an embodiment may include: a housing (1000), a syringe automation unit (2000), a liquid medicine container transfer automation unit (3000), a control unit (not shown), and an operation unit (4000).

In this embodiment, the automated liquid medicine transfer apparatus (100) includes the liquid medicine container transfer automation unit (3000), which automates the sequential process in which a container with the liquid medicine to be extracted (hereinafter referred to as the ‘extraction container’) and a container into which the extracted liquid medicine is injected (hereinafter referred to as the ‘injection container’) are connected to a syringe. It also includes the syringe automation unit (2000), which automates the process of the syringe extracting and injecting the liquid medicine. This results in an automated device for transferring liquid medicine between containers.

In one embodiment, the housing (1000) is provided in a rectangular parallelepiped shape to allow it to stand on various floor surfaces. However, it is not limited to this and may take any form that can be installed on the ground and support the internal components and the movement of the liquid medicine container transfer automation unit (3000).

In one embodiment, the syringe automation unit (2000) and the operation unit (4000) may be positioned on the front of the housing (1000). The liquid medicine container transfer automation unit (3000) may be located on top of the housing (1000), separated from it, in such a way that the medicine container to be gripped and moved in orthogonal directions can be connected to and disconnected from the syringe. The drive parts of the syringe automation unit (2000) and the liquid medicine container transfer automation unit (3000) may be positioned inside the housing (1000) to avoid external exposure, although this is not a limitation.

In this embodiment, the syringe automation unit (2000) may be positioned on the front of the housing (1000), although it is not limited to this configuration.

The syringe automation unit (2000) may include: a barrel fixing unit (2100) to secure the syringe to a predetermined position on the front of the housing, a piston gripping unit (2200) to grip the handle of the syringe piston for its motion, and a syringe drive unit (2300) to raise and lower the piston gripping unit (2200) or the barrel fixing unit (2100) to perform the piston motion.

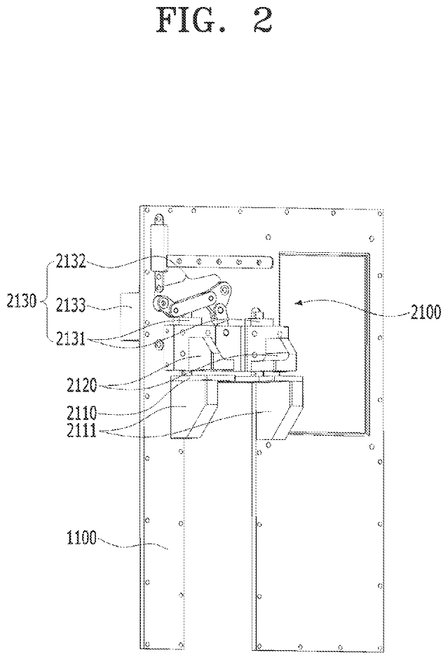

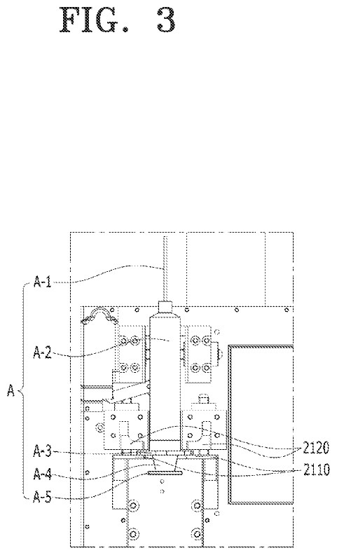

FIG. 2 is a perspective view of the barrel fixing unit (2100) according to one embodiment. FIG. 3 is a front view of the same.

Referring to FIGS. 1 through 3, in the syringe automation unit (2000) according to one embodiment, the barrel fixing unit (2100) grasps the handle (A-3) of the syringe (A) to secure the syringe to a predetermined position on the front of the housing (1000).

In this embodiment, the barrel fixing unit (2100) is arranged such that a barrel center adjustment gripper (2140) (described later) is at the top, and the syringe drive unit (2300) is at the bottom. Therefore, the inserted or mounted syringe (A) is positioned such that the syringe needle (A-1) faces vertically upward, and the piston handle (A-5) faces vertically downward.

The barrel fixing unit (2100) may include: a syringe handle support plate (2110), a syringe handle pressing plate (2120), and a pressing plate drive unit (2130).

The syringe handle pressing plate (2120) supports all or part of the bottom surface of the syringe handle (A-3), allowing the syringe barrel (A-2) to rest on the front panel (1100) of the housing (1000).

In one embodiment, the syringe handle support plate (2110) is a flat plate that parallels the bottom of the syringe handle (A-3) but is not limited to this.

The bottom of the syringe handle support plate (2110) may also include a reinforcing rib (2111) to enhance support strength.

The syringe handle pressing plate (2120) presses the top surface of the syringe handle (A-3) to secure the syringe in place together with the syringe handle support plate (2110).

In one embodiment, the syringe handle pressing plate (2120) is positioned above the syringe handle support plate (2110) with a certain gap to allow the insertion of the syringe handle (A-3). This gap is provided for this purpose.

The syringe handle pressing plate (2120) can be configured in various forms to press and fix the handle (A-3) during the downward movement of the pressing plate drive unit (2130).

It may be shaped as a plate or polyhedron protruding from the front panel (1100) and parallel to the syringe handle but is not limited to this.

The syringe handle pressing plate (2120) moves up and down on the syringe handle support plate (2110), driven by the pressing plate drive unit (2130). In its downward motion, it presses the inserted syringe handle (A-3) to secure it. In its upward motion, it allows the syringe to be removed from the barrel fixing unit (2100).

Alternatively, the syringe handle pressing plate (2120) may be located under the syringe handle support plate (2110) with a certain gap and move upward to press and secure the syringe handle (A-3) or move downward to release it.

The pressing plate drive unit (2130) includes: a linear motion guide rail (not shown), a linear motion guide block (2131), a linkage mechanism (2132), and an actuator (2133).

The linear motion guide rail is mounted vertically on the front panel (1100).

The linear motion guide block (2131) moves vertically along the rail and has the syringe handle pressing plate (2120) attached to one side, guiding its vertical motion.

The linear motion guide block (2131) connects to the actuator (2133) via the linkage mechanism (2132), allowing vertical movement powered by the actuator.

These components may be of commonly used types and specifications in the relevant technical field.

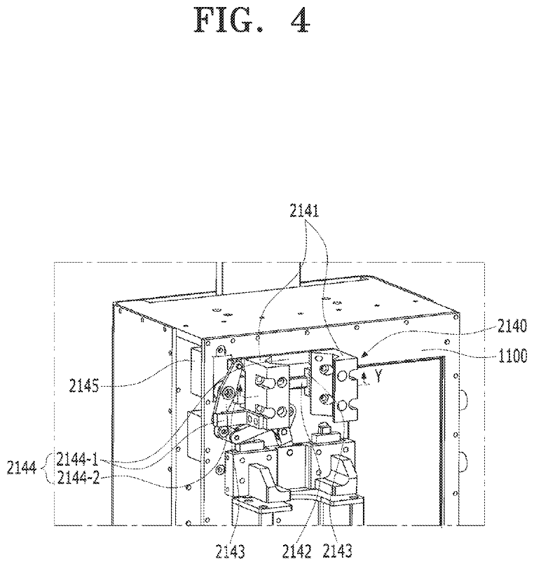

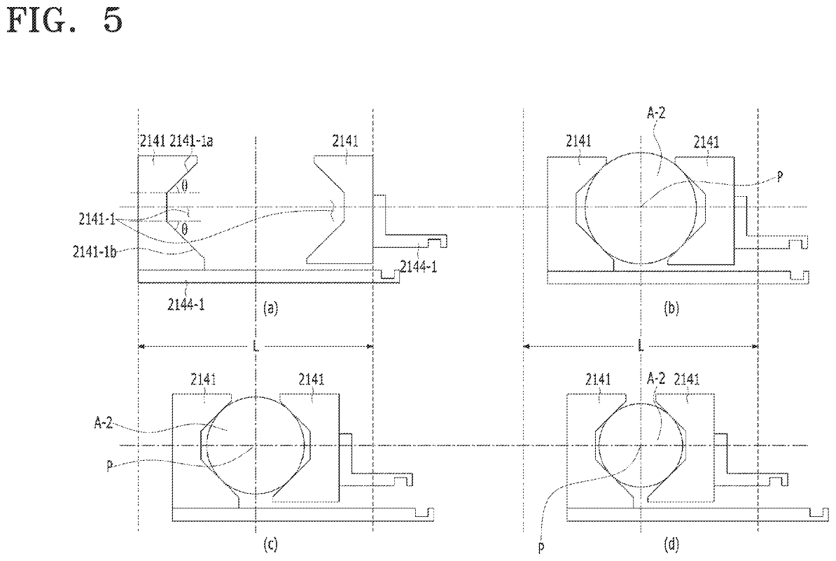

FIG. 4 is a perspective view of a first gripper according to one embodiment. FIG. 5 is a cross-sectional view along the Y-axis of FIG. 4 showing the first gripper holding cylinders of various capacities.

Referring to FIGS. 4 and 5, the barrel fixing unit (2100) according to one embodiment may further include a first gripper (2140) that adjusts the syringe (A) so that its center axis (A-2) aligns with a predetermined axis (P).

In this embodiment, as the syringe (A) is inserted with the needle (A-1) pointing upward, the first gripper (2140) may be located at the top of the syringe handle pressing plate (2120).

The first gripper (2140) may include: a pair of first gripper arms (2141), a linear motion guide rail (2142), a linear motion guide block (2143), a linkage mechanism (2144), and an actuator (2145).

In this embodiment, the first gripper (2140) is configured as a parallel-motion gripper that opens and closes by moving along an axis perpendicular to the predetermined axis (P).

For example, the linear motion guide rail (2142) may be mounted on the front panel (1100) in an orientation perpendicular to the predetermined axis (P). A linear motion guide block (2143) is coupled to the linear motion guide rail (2142) and connected to an actuator (2145) via a linkage mechanism (2144). The pair of first gripper arms (2141) may be respectively connected to corresponding linear motion guide blocks (2143) and configured to move along an axis perpendicular to the predetermined axis (P), thereby performing an opening and closing operation.

In one embodiment, the pair of first gripper arms (2141) may be configured to perform the opening and closing operation by moving in opposite directions and by the same distance with respect to the predetermined axis (P). To this end, each of the first gripper arms (2141) may be provided with a link bar (2144-1), which is connected to a servo horn (2144-2).

As illustrated in FIG. 4, the servo horn (2144-2) may rotate about a rotational axis coupled to the actuator (2145) and may be configured with arms extending in opposite directions with equal length from the axis of rotation.

Accordingly, the link bars (2144-1) connected to each end of the servo horn (2144-2) are displaced in opposite directions by the same distance due to the rotation of the servo horn (2144-2).

Thus, the pair of first gripper arms (2141), each coupled to a respective link bar (2144-1), may be displaced by the same distance in opposite directions with respect to the predetermined axis (P), thereby performing an opening and closing operation. As a result, the center of the inserted syringe barrel (A-2) may always be positioned along the predetermined axis (P).

In one embodiment, the pair of first gripper arms (2141) may be formed symmetrically with respect to the predetermined axis (P), and each of the first gripper arms (2141) may extend in a direction parallel to the predetermined axis (P).

For example, each (of the first gripper arms (2141)) may be formed as a block extending in the direction of the predetermined axis (P), thereby stably gripping the outer circumferential surface of the barrel along its longitudinal direction.

In one embodiment, the first gripper arm (2141) may include a first recess (2141-1) formed on the gripping surface (e.g., the surface facing the barrel) to stably grip the outer circumferential surface of the syringe barrel (A-2) and assist in aligning the center of the barrel (A-2) with the predetermined axis (P).

To this end, in one embodiment, the first recess (2141-1) may be formed symmetrically with respect to a parallel translation axis (L) in the cross-sectional shape taken perpendicular to the predetermined axis (P) (e.g., as shown in the cross-section of the first gripper arm (2141) in FIG. 5). The cross-sectional shape thus extended along the predetermined axis (P) may be formed as a combination of flat surfaces or as a curved surface.

Here, the parallel translation axis refers to an axis parallel to the direction in which the pair of first gripper arms (2141) move in parallel along the linear motion guide rail (2142) to perform the opening and closing operations (e.g., axis L in FIG. 5).

In one embodiment where the first recess (2141-1) is formed by a combination of planar surfaces, the first recess (2141-1) may include a first inclined surface (2141-1a) forming a first angle (θ) with the parallel translation axis of the first gripper arm (2141), and a second inclined surface forming a second angle (−θ) with the same axis. The first and second angles may be equal in magnitude and opposite in sign.

Accordingly, the first gripper (2140) may ensure that the center of the syringe (A), regardless of its size or volume, remains aligned with the predetermined axis (P), and the syringe (A) fixed in the barrel fixing unit (2100) may be prevented from moving forward (e.g., in a direction perpendicular away from the front panel (1100)) or backward (e.g., in a direction perpendicular toward the front panel (1100)).

For example, referring to FIG. 5, in a plane perpendicular to the predetermined axis (P), the pair of first gripper arms (2141) perform the opening and closing operation by moving in parallel in opposite directions about the predetermined axis (P). In this case, the first gripper arms (2141) are formed symmetrically with respect to each other, and the first recesses (2141-1) having the first inclined surface (2141-1a) and second inclined surface (2141-1b) are formed on the respective gripping surfaces.

Further, the first inclined surface (2141-1a) and second inclined surface (2141-1b) respectively form inclinations with the parallel translation axis of the first gripper arm (2141), having equal magnitude but opposite signs, and are arranged symmetrically about the translation axis intersecting the predetermined axis (P).

As a result, even if the outer diameter of the barrel (A-2) varies depending on the size or volume of the syringe, the center of the barrel (A-2) remains located on the predetermined axis (P).

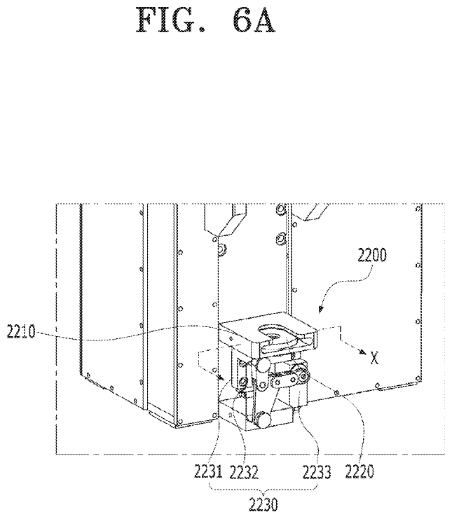

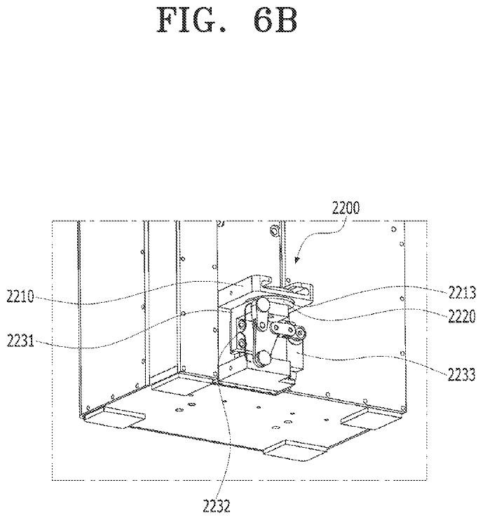

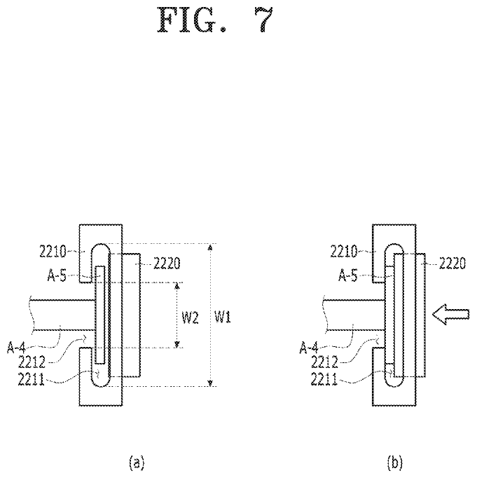

FIGS. 6A and 6B are perspective views of a piston gripping unit according to an exemplary embodiment. FIG. 7 is a sectional view taken along the X-axis direction of FIG. 6A showing the piston gripping unit.

Referring to FIGS. 6A to 7, in a syringe automation device (2000) according to an exemplary embodiment, a piston gripping unit (2200) may support the upper and lower surfaces of the piston handle (A-5) of the syringe to stably grip the piston for its actuation.

To this end, in one example, the piston gripping unit (2200) may include a piston handle gripping frame (2210) having a slot into which a portion of the piston handle (A-5) and piston rod (A-4) may be inserted.

In one example, the piston handle gripping frame (2210) may include a first slot (2211) having a first width (W1), where the first width (W1) corresponds to the insertion width of the piston handle (A-5). For instance, since syringes with capacities of 20 mL, 30 mL, or 50 mL are commonly used in drug preparation, such as in chemotherapy, the first width (W1) may be greater than or equal to the diameter of the piston handle (A-5) of a 50 mL syringe.

In one embodiment, the piston handle gripping frame (2210) may also include a second slot (2212) having a second width (W2), which is connected to the upper side of the first slot (2211) considering the mounting orientation of the syringe (A) in the barrel fixing unit (2100). The second width (W2) may be smaller than the diameter or width of the piston handle (A-5) to prevent the piston handle (A-5) from escaping upward during downward motion of the piston gripping unit (2200), and larger than the width or diameter of the piston rod (A-4) to allow its insertion.

For example, the second width (W2) may be smaller than the diameter of the piston handle (A-5) of a 20 ml syringe (smallest), and greater than the diameter of the piston rod (A-4) of a 50 ml syringe (largest), thereby allowing syringes of various capacities to be gripped using a single piston handle gripping frame (2210).

In one embodiment, the piston gripping unit (2200) may include a pressing plate insertion hole (2213) penetrating the bottom (or lower surface) of the piston handle gripping frame (2210) and communicating downward with the first slot (2211), a piston handle pressing plate (2220) inserted therein, and a drive unit (2230).

The piston handle pressing plate (2220) is elevated by the drive unit (2230) after the piston handle (A-5) is inserted into the piston handle gripping frame (2210), thereby pressing and supporting the lower surface of the piston handle (A-5). As a result, the upper surface of the piston handle (A-5) is supported by the gripping frame (2210), while the lower surface is pressurized and supported by the piston handle pressing plate (2220), enabling stable gripping during repetitive piston motions and minimizing dosing error during extraction or injection.

In one embodiment, the pressing plate insertion hole (2213) may be formed in various shapes corresponding to the shape of the piston handle pressing plate (2220). The piston handle pressing plate (2220) may be formed as a circular plate corresponding to the piston handle (A-5) for stable pressing, although not limited thereto.

In one embodiment, the drive unit (2230) for the piston handle pressing plate (2220) may include a linear motion guide rail (not shown), a linear motion guide block (2231), an actuator (2233) that provides driving force for vertical movement, and a link mechanism (2232) connecting the actuator (2233) to the linear motion guide block (2231). However, the configuration is not limited to this example.

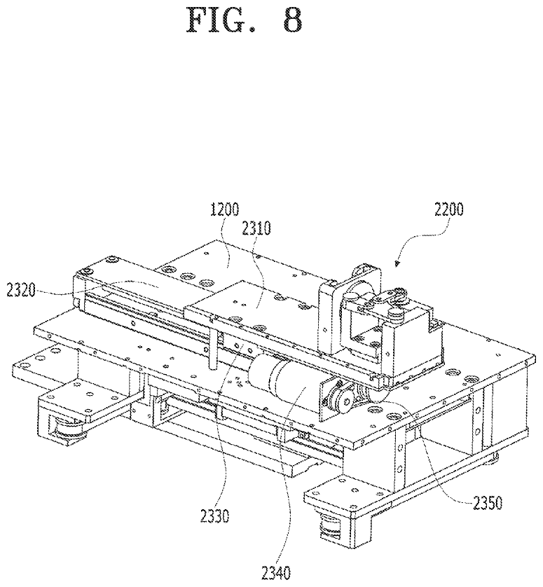

FIG. 8 is a perspective view of a piston gripping unit and a syringe drive unit according to an exemplary embodiment.

Referring to FIG. 8, in the syringe automation unit (2000), the syringe drive unit (2300) may be configured to relatively move the barrel fixing unit (2100) and piston gripping unit (2200) to perform piston motion for drawing or injecting a liquid.

More specifically, in one exemplary embodiment, the syringe drive unit (2300) may raise or lower the piston gripping unit (2200) to actuate the piston of the syringe barrel (A-2), which is held stationary.

In this case, as described later, the controller may be configured to pull the piston for drug extraction by lowering the piston gripping unit (2200), and to push the piston for injection by raising the piston gripping unit (2200).

Alternatively, in another example, the syringe drive unit (2300) may fix the piston gripping unit (2200) and instead move the barrel fixing unit (2100), such that the syringe barrel (A-2) moves relative to the fixed piston (A-4, A-5) to perform piston motion.

In this case, as will be described later, the controller may be configured to raise the syringe drive unit (2300) for extraction and to lower it for injection.

As an example of the syringe drive unit (2300) for performing the functions described above, the syringe drive unit (2300) may be attached or supported on the support frame (1200) inside the housing (1000), and may include: a linear motion guide rail (2320) having a vertical axis with respect to the ground; a linear motion guide block (2330) that moves upward or downward along the linear motion 2310 guide rail (2320); a piston gripping unit transfer plate (2310) that connects the linear motion guide block (2330) to the piston gripping unit (2200); and a piston drive unit motor (2340) that applies a driving force to the linear motion guide block (2330).

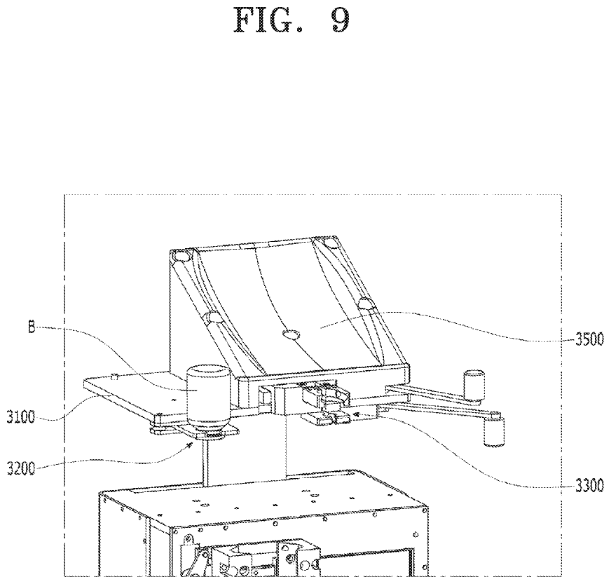

FIG. 9 is a perspective view of the automated liquid medicine container transfer apparatus according to one embodiment.

Referring to FIG. 9, in the automated liquid medicine transfer apparatus (100) using a syringe according to one embodiment, the liquid medicine container transfer automation unit (3000) performs the functions of gripping a liquid medicine container, moving in an orthogonal direction relative to the syringe held by the syringe automation unit (2000), and connecting or disconnecting the container and the syringe.

The liquid medicine container transfer automation unit (3000), according to one embodiment, may include a first frame (3100), a first gripping unit (3200), a second gripping unit (3300), and a frame transfer unit (3400).

In one embodiment, the first frame (3100) may be provided in the form of a plate. However, the disclosure is not limited thereto, and any structure having a sufficient area to mount the first gripping unit (3200) and second gripping unit (3300), and capable of enabling movement by the frame transfer unit (3400), should be interpreted as falling within the scope of the present disclosure. For example, it may be formed solely of an outer frame.

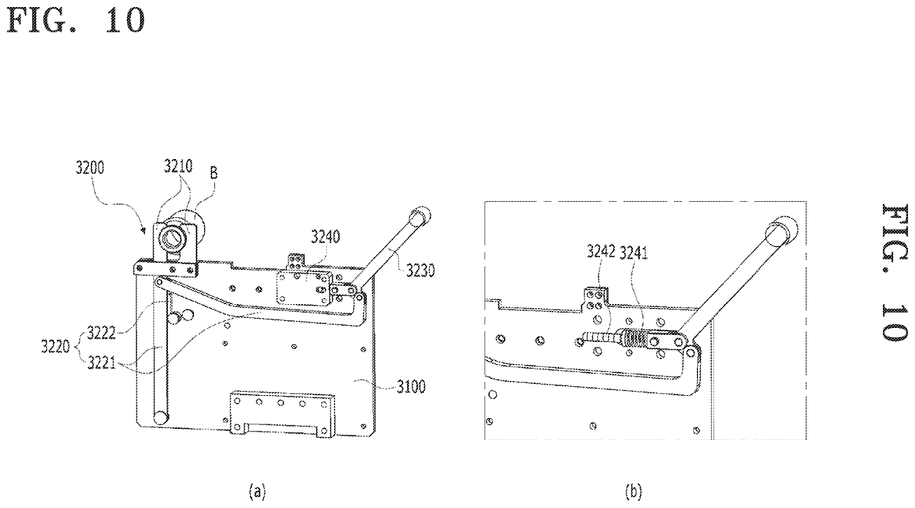

FIG. 10 is a diagram showing the structure of the second gripper and the toggle operation unit of the second gripper according to one embodiment.

Referring to FIGS. 9 through 10, in the liquid medicine container transfer automation unit (3000) according to one embodiment, the first gripping unit (3200) functions to grip a container that contains the liquid medicine to be extracted (hereinafter referred to as the ‘extraction container’). The extraction container may be a vial. However, the disclosure is not limited thereto and may also include gripping other types of liquid medicine containers such as IV bags.

However, the first gripping unit (3200) is not limited to the above-described configuration, and it is apparent that the first gripping unit (3200) may also grip an intravenous (IV) bag containing a liquid medicine.

In one embodiment, the first gripping unit (3200) may be provided on one side of the first frame (3100). The inlet of the extraction container gripped by the first gripping unit (3200) and the inlet of the injection container (i.e., a container into which the extracted liquid medicine is to be injected, hereinafter referred to as the ‘injection container’) gripped by the second gripping unit (3300) may be aligned in a row.

These inlets may be arranged not only in a row but also in parallel with one of the movement axes of a frame moving unit (3400), which will be described later. This configuration enables the frame moving unit (3400) to transport the extraction container to a first position corresponding to a syringe and the injection container to a second position corresponding to the syringe using only two-axis orthogonal movement.

Accordingly, compared to a device requiring three-axis movement, the automated liquid medicine transfer apparatus (100), which transfers liquid medicine using a syringe, may be simplified in structure. This simplification reduces manufacturing costs, enhances cost competitiveness, and enables firm and accurate connection between the syringe and the medicine container.

In one embodiment, the first gripping unit (3200) may grip the extraction container such that its inlet faces vertically downward. As a result, the syringe needle (A-1) of the syringe (A), which is fixed to the barrel fixing unit (2100), can be aligned with the inlet of the extraction container. This configuration allows the syringe (A) and the extraction container to be connected solely by vertical movement of either the syringe (A) or the extraction container, without requiring rotational alignment.

In one embodiment, the first gripping unit (3200) may include a second gripper (3200) configured to grip a vial (B). The second gripper (3200) may utilize a toggle mechanism that maintains the open or closed state with a predetermined elastic or support force, such as by using a spring or a similar component. This toggle-based structure allows the second gripper (3200) to securely and stably grip the extraction container in the closed state.

To this end, the second gripper (3200) may comprise a pair of second gripper arms (3210), a link mechanism (3220), an operating lever (3230), and a toggle operating unit (3240).

For example, as illustrated in FIG. 10(a), the pair of second gripper arms (3210) may be connected to the operating lever (3230) via the link mechanism (3220), and the toggle operating unit (3240) may be connected to one side of the operating lever (3230) to enable opening and closing via the toggle mechanism.

The degree of opening and closing of the second gripper (3200) may be adjusted by the elasticity of a toggle spring (3241), or by a preload adjustment set screw (3242) that adjusts the preload force applied to the toggle spring (3241), as shown in FIG. 10(b).

In one embodiment, the second gripper (3200) may be configured to open to a width of 17 mm or more. Vials commonly used in pharmaceutical preparation processes (e.g., anticancer drugs) typically range from 5 mL to 50 mL in volume, with neck diameters of approximately 15.6 mm to 16.7 mm. Therefore, a gripper opening width of 17 mm or more allows for stable gripping of vials (B) within this capacity range.

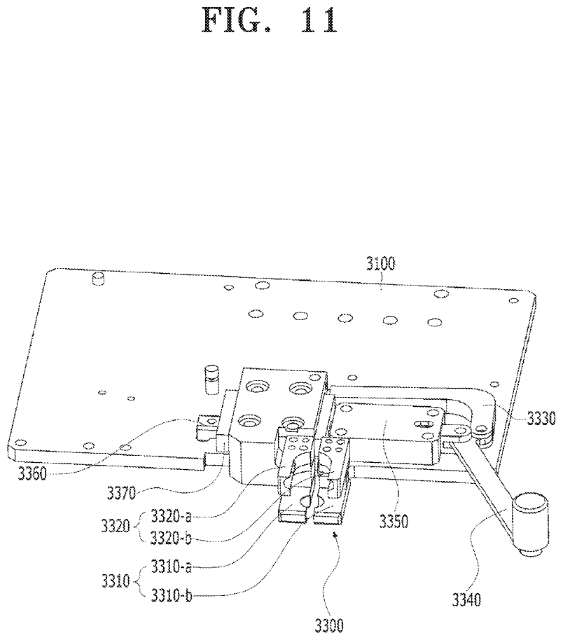

FIG. 11 illustrates a perspective view of a second gripping unit (3300) according to one embodiment.

Referring to FIG. 11, the second gripping unit (3300) in the liquid medicine container transfer automation unit (3000) is configured to grip an injection container, such as an IV bag (C). However, the second gripping unit (3300) is not limited thereto and may also grip a vial (B), using the same configuration as described for the first gripping unit (3200).

In one embodiment, the second gripping unit (3300) may be disposed on one side of the first frame (3100), spaced apart from the first gripping unit (3200). The inlet of the injection container gripped by the second gripping unit (3300) may be aligned with the inlet of the extraction container gripped by the first gripping unit (3200), facilitating efficient fluid transfer.

In one embodiment, the second gripping unit (3300) may be configured to grip the injection container with its inlet facing vertically downward. The second gripping unit (3300) may include at least one of the following: a third gripper (3310) configured to grip an IV bag with a cylindrical inlet, a fourth gripper (3320) configured to grip an IV bag with a polyhedral inlet, or a combination thereof.

IV bags with different inlet geometries are commonly used depending on their size or volume. Generally, small-capacity IV bags have circular pipe-shaped inlets, while larger-capacity bags feature polyhedral inlets, often with two parallel sides. Therefore, to ensure stable gripping of IV bags of various sizes and shapes, it is desirable for the second gripping unit (3300) to include at least two types of grippers.

In one embodiment, both a third gripper (3310) and a fourth gripper (3320) may be simultaneously provided and vertically arranged to perform coordinated opening and closing operations. However, the configuration is not limited thereto. In another embodiment, the third and fourth grippers may operate using a toggle mechanism. Alternatively, the third and fourth grippers may form a parallel movement gripper group in which respective pairs of gripper arms (3310-a, b; 3320-a, b) move in parallel to perform gripping actions.

As shown in FIG. 11, the third gripper (3310) and fourth gripper (3320) may be vertically arranged on one side of a first frame (3100). In such a configuration, gripper arms (3310-b, 3320-b) on one side may be fixed to the first frame (3100), while gripper arms (3310-a, 3320-a) on the opposite side may be mounted to a linear motion guide block (3370). The linear motion guide block (3370) is connected to an operation lever (3340) via a link mechanism (3330), which is driven by a toggle operation unit (3350). This configuration allows the gripper arms (3310-a, 3320-a) to move in parallel along a linear motion guide rail (3360) provided on the first frame (3100), thereby achieving synchronized opening and closing actions.

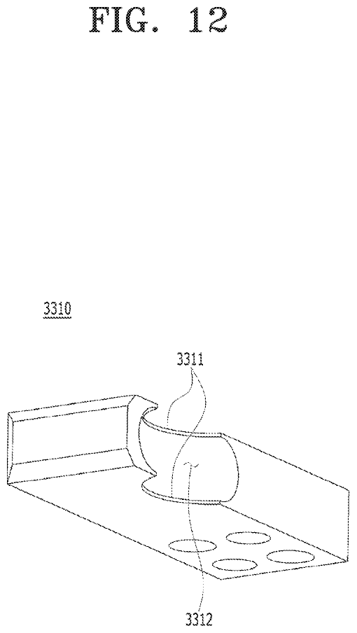

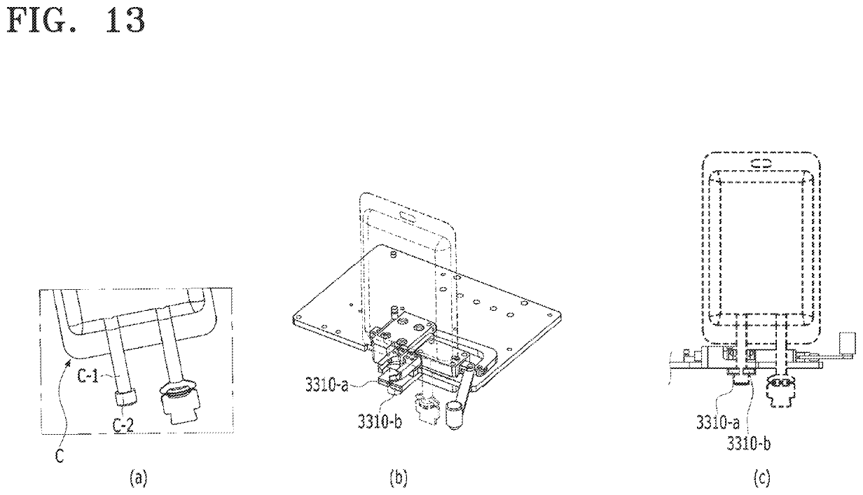

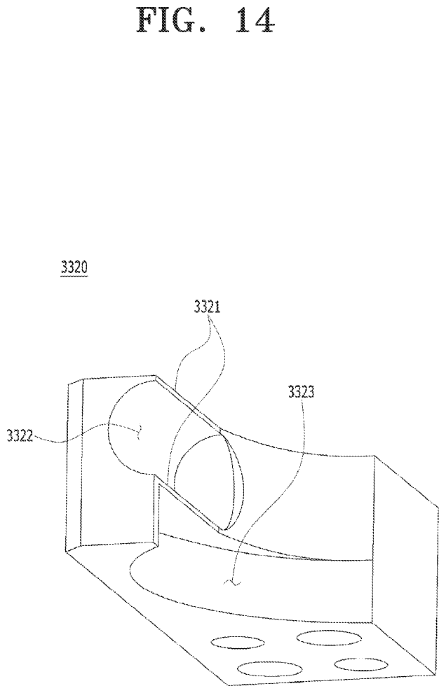

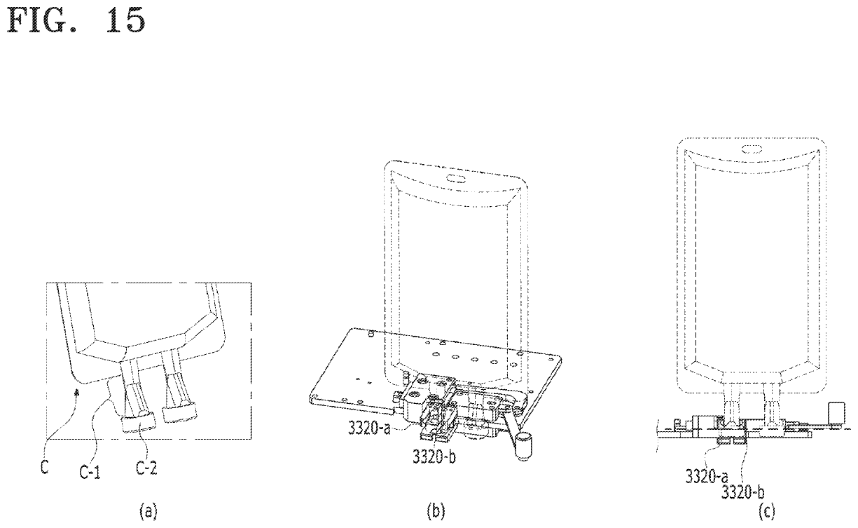

FIG. 12 illustrates a portion of a third gripper arm; FIG. 13 shows the third gripper gripping an IV bag with a cylindrical inlet. FIG. 14 illustrates a portion of a fourth gripper arm; FIG. 15 shows the fourth gripper gripping an IV bag with a polyhedral inlet.

As shown in FIGS. 12 and 14, the third and fourth grippers (3310, 3320) may include gripper teeth (3311, 3321) on the gripping surfaces of the respective arms (3310-a, b; 3320-a, b). The gripper teeth may have relatively sharp ends due to their protruding structure or surrounding recessed areas, thereby concentrating pressure on the bag inlet during gripping.

In some embodiments, the shape of the gripper teeth (3311, 3321) corresponds to the inlet shape of the IV bag. For example, the third gripper (3310), designed to grip a cylindrical inlet, may feature semicircular teeth (FIG. 12), whereas the fourth gripper (3320), adapted for polyhedral inlets, may include straight-line teeth (FIG. 14). However, the teeth may take any shape that conforms to the external geometry of the object being gripped.

Multiple gripper teeth may be spaced vertically on each gripping surface. This configuration does not preclude embodiments in which only a single tooth is provided per gripping surface. The gripper teeth (3311, 3321) may be oriented perpendicularly to the vertical axis (i.e., parallel to the ground), enabling vertical support of the inlet (C-1) from above and below, thereby preventing lateral tilting during gripping.

When the syringe needle (A-1) penetrates the bag inlet (C-1), upward force may cause slippage. However, most IV bags include a protrusion (C-2) near the inlet. The horizontally arranged gripper teeth (3311, 3321) can support this protrusion, preventing upward displacement and ensuring height stability of the gripped bag.

Additionally, as shown in FIGS. 14 and 15, an insertion groove (3323) may be formed on the lower surface of the gripper teeth to receive and support the inlet protrusion (C-2), stabilizing the position of the bag even under upward forces during syringe insertion. This prevents vertical misalignment and facilitates consistent syringe-to-bag engagement.

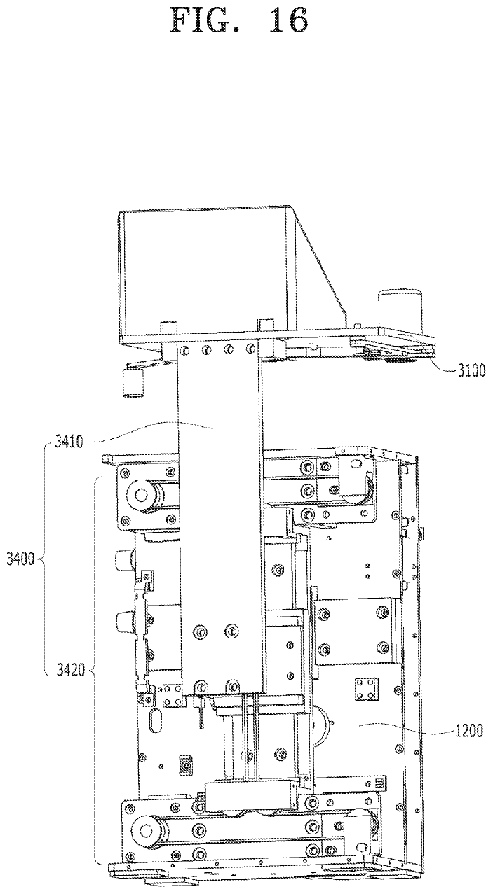

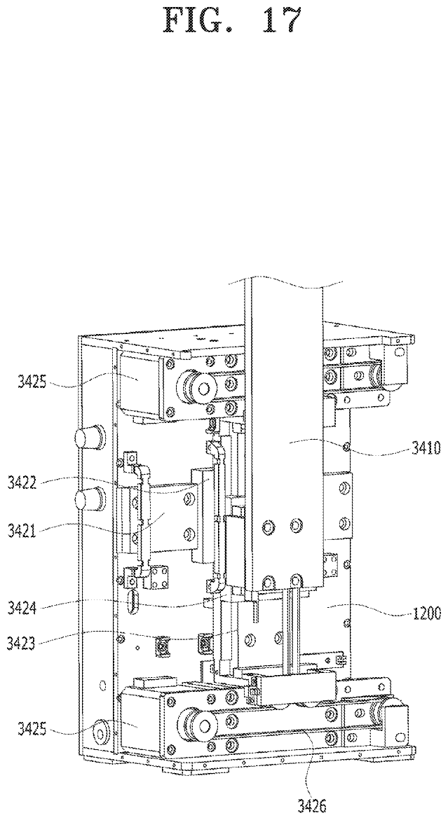

FIG. 16 illustrates a frame moving unit (3400), and FIG. 17 depicts an orthogonal moving device. In one embodiment of the liquid medicine container automation unit (3000), the frame moving unit (3400) connects to the first frame (3100) and enables its movement.

The frame moving unit (3400) may be configured for two-axis orthogonal movement-one axis vertical and the other horizontal. Given the spatial relationship between the first frame (3100) and the gripping units (3200, 3300), only two-axis movement is required to align the syringe with either the extraction or injection container. This results in improved accuracy and mechanical stability over three-axis systems, as well as reduced size and cost.

The frame moving unit (3400) may move the first frame (3100) between a first position (for liquid extraction) and a second position (for injection). To achieve this, the frame moving unit (3400) may include an orthogonal moving device (3420) and a link frame (3410) connecting the orthogonal moving device (3420) to the first frame (3100). The link frame (3410) may be implemented as a plate or any structure capable of transmitting actuation force.

The orthogonal moving device (3420) may include vertical and horizontal linear motion guide rails (3421, 3423), vertical and horizontal linear motion guide blocks (3422, 3424) movably coupled to the respective rails, an actuator (3425) configured to drive the linear motion, and a link mechanism (3426), such as a timing belt, to transmit the driving force.

In one embodiment, the link frame (3410) may be formed as a plate; however, this structure is not limiting. Any configuration in which the driving force generated by the orthogonal moving device (3420) is transmitted to the first frame (3100) by connecting the first frame (3100) to the orthogonal moving device (3420) may fall within the scope of the present disclosure.

In some embodiment, the orthogonal moving device (3420) may comprise: vertical and horizontal linear motion guide rails (3421, 3423) mounted to a support frame (1200) inside the housing (1000); linear motion guide blocks (3422, 3424) coupled to the respective rails and configured to move vertically and horizontally; an actuator (3425) for driving the movement of the guide blocks; and a link mechanism (3426), such as a timing belt, that transmits the actuator's driving force to the guide blocks.

Referring to FIG. 9, the liquid medicine container transfer automation unit (3000) according to one embodiment may further include an IV bag holder (3500) configured to support a pouch-type liquid medicine container on the first frame (3100).

When the liquid medicine container is an IV bag (C), the pouch portion of the IV bag constitutes most of its weight. Upon injection of the liquid, the pouch may lose its structural integrity and collapse due to the weight. The IV bag holder (3500) is configured to support the IV bag (C) to prevent it from tipping over, thereby reducing the risk of damage and ensuring that the collapsed pouch does not obstruct fluid flow.

In one embodiment, the IV bag holder (3500) may be mounted at a predetermined height on the first frame (3100) such that the IV bag (C) is supported in proximity to either the first gripping unit (3200) or the second gripping unit (3300).

Additionally, the IV bag holder (3500) may include an inclined surface that decreases in height toward the first gripping unit (3200) or the second gripping unit (3300). Accordingly, even if the inlet (C-1) of the IV bag is gripped by the first or second gripping unit and the pouch portion collapses during liquid injection, the inclined surface provides stable support to the pouch, thereby minimizing the risk of damage or blockage in the injection flow due to excessive bending.

Referring to FIG. 1, the liquid medicine movement automation apparatus (100) using a syringe, according to one embodiment, may include a controller (not shown) configured to control both the syringe automation unit (2000) and the liquid medicine container transfer automation unit (3000) within the housing (1000).

In one embodiment, the controller may be electrically connected to the syringe driving unit (2300) and the frame moving unit (3400), and configured to lower the syringe driving unit (2300) for extracting liquid medicine when the first frame (3100) is positioned at a first location, and to raise the syringe driving unit (2300) to inject the liquid medicine when the frame is positioned at a second location.

For example, the liquid medicine movement process using the syringe may be performed as follows. When a syringe (A) is inserted into both the barrel fixing unit (2100) and the piston grip unit (2200), the first gripper (2140) performs a closing operation to align the syringe barrel (A-2) with a predetermined axis (P). The barrel handle pressing plate (2120) then moves downward to press and secure the barrel handle (A-3). Subsequently, the piston handle pressing plate (2220) ascends to grip the piston handle (A-5) securely on the piston handle grip unit (2210), ensuring the syringe (A) is firmly held within the syringe automation device (2000).

Thereafter, the frame moving unit (3400) moves the first frame (3100) horizontally so that the inlet of an extraction container (B) aligns with the needle (A-1) of the syringe (A) and then moves the frame downward to insert the needle into the extraction container (B). The syringe driving unit (2300) then moves downward to retract the piston and extract liquid medicine from the extraction container (B) into the syringe (A). Once the volume specified via the operating unit (4000) has been extracted, piston movement ceases.

The frame moving unit (3400) then raises the first frame (3100) to withdraw the syringe (A) from the extraction container (B) and moves the frame horizontally to align the injection container (C) with the syringe (A). The needle (A-1) is then inserted into the injection container (C) via downward movement, and the syringe driving unit (2300) moves upward to inject the liquid medicine into the injection container (C).

Once injection is complete, the frame moving unit (3400) lifts the first frame (3100) to separate the syringe (A) from the injection container (C), thus concluding the liquid medicine transfer process.

Referring again to FIG. 1, the liquid medicine movement automation apparatus (100) using a syringe may further include an operating unit (4000) configured to input commands to the controller. The operating unit (4000) may include a touch panel or similar interface and may be mounted on the front of the housing (1000). However, this configuration is exemplary, and the operating unit (4000) may be positioned variably depending on the installation environment or user preferences.

### Modified Embodiment 1

A modified embodiment of the present disclosure will now be described. In the following description, redundant details with the previously described embodiment are either omitted or briefly summarized, with emphasis placed on distinguishing features. Components that are the same as those in the previous embodiment are denoted with the same reference numerals and may be interpreted as having identical structures, functions, operations, and effects.

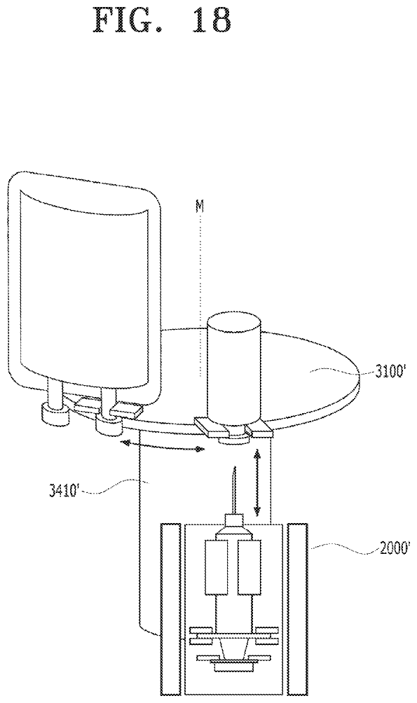

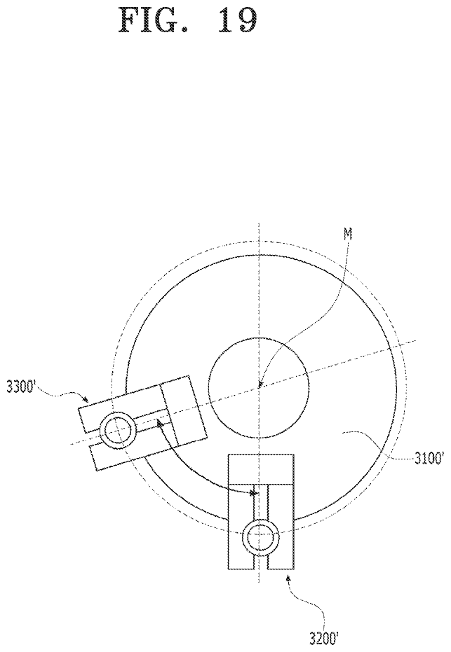

FIG. 18 is a perspective view, and FIG. 19 is a plan view, illustrating a modified embodiment 1.

Referring to FIGS. 18 and 19, in this embodiment, a frame transfer unit (3400′) may be configured to rotate about a rotation axis (M). Alternatively, the frame moving unit (3400′) may be configured both to rotate about the rotation axis (M) and to move in the vertical direction.

As illustrated in FIG. 18, the frame transfer unit (3400′) supports a first frame (3100′), and a link frame (3410′) in the form of a pillar connects the first frame (3100′) to a drive unit (not shown). The link frame (3410′) may be configured to rotate about the rotation axis (M) and to move vertically. However, the present disclosure is not limited thereto. In one variation, the frame transfer unit (3400′) may perform only rotational motion, while the vertical movement may instead be performed by a syringe automation unit (2000′) driven by a separate actuator (not shown).

In an example, the first frame (3100′) may be disk-shaped and configured to rotate about the rotation axis (M) in conjunction with the motion of the frame transfer unit (3400′). The first frame (3100′) may be mounted on the upper surface of the frame moving unit (3400′).

In this embodiment, a first gripping unit (3200′) and a second gripping unit (3300′) may be disposed along the circumference of the disk-shaped first frame (3100′) such that the inlets of both the extraction and injection containers are equidistant from the rotation axis (M).

Accordingly, the frame moving unit (3400′) can move the first frame (3100′) between a first position (where the extraction container is aligned with the syringe) and a second position (where the injection container is aligned with the syringe) by rotating about the rotation axis (M) and moving along a single vertical axis.

For instance, as shown in FIGS. 18 and 19, when the first frame (3100′) is in the first position, the syringe automation unit (2000′) operates to extract liquid medicine from the extraction container (B), which may be, for example, a liquid medicine vial. Subsequently, when the frame moving unit (3400′) transitions the first frame (3100′) to the second position through additional rotation and/or vertical movement, the syringe automation unit (2000′) is actuated to inject the extracted liquid into an injection container (C), such as an IV bag. This arrangement enables efficient transfer of the liquid medicine.

This modified embodiment of the automated liquid medicine transfer apparatus (100′) offers the significant advantage of enhanced usability through a more compact operational footprint.

### Modified Embodiment 2

Another modified embodiment of the present disclosure will now be described. As before, repetitive descriptions with respect to prior embodiments are omitted or briefly noted, with a focus on differences. Identical components are denoted with the same reference numerals and may be interpreted as having the same structure, function, operation, and effect.

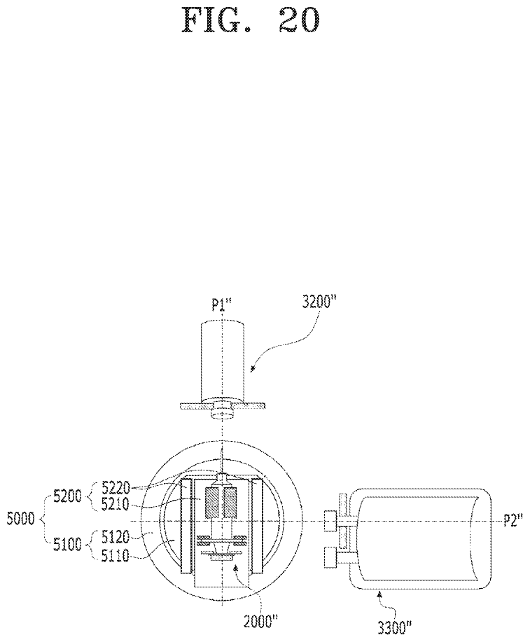

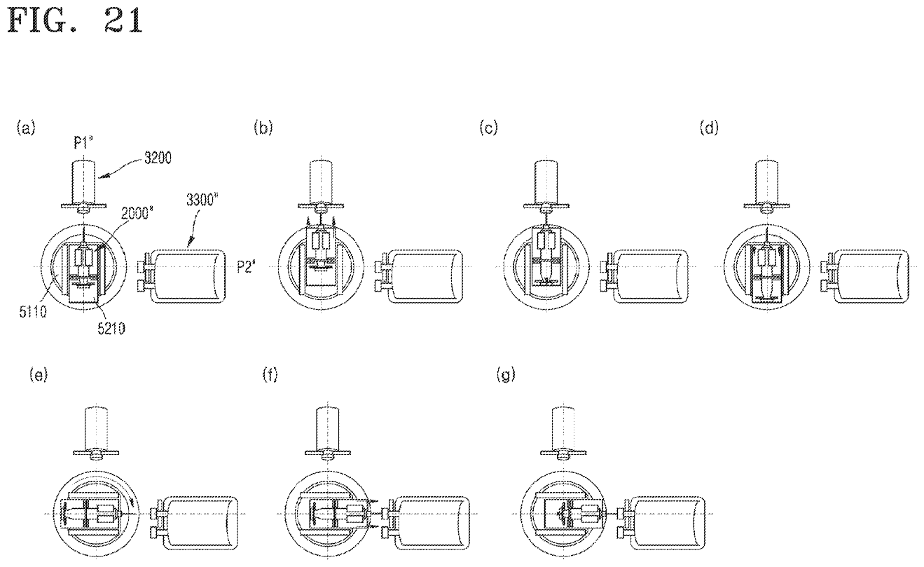

FIG. 20 shows a front view of modified embodiment 2, while FIG. 21 illustrates an operating sequence of the same.

This embodiment features a further simplified moving unit configuration that enhances the stability of liquid transfer and provides advantages in terms of space efficiency.

Modified embodiment 2 may comprise a housing (1000), a syringe automation device (2000), a third gripping unit (3200″), a fourth gripping unit (3300″), a syringe transfer unit (5000), a controller (not shown), and an operating unit (4000).

The housing (1000), syringe automation unit (2000), and operating unit (4000) may be configured in the same manner as previously described embodiments, and their detailed descriptions are omitted.

In this embodiment, the third gripping unit (3200″) is positioned around the syringe automation unit (2000) and configured to grip an extraction container containing the liquid to be extracted. The fourth gripping unit (3300″) is spaced apart from the third gripping unit (3200″) and configured to grip an injection container for receiving the extracted liquid.

The term ‘around’ refers to a positional arrangement in which the syringe held by the syringe automation unit (2000) can align with and connect to either the extraction or injection container through the motion of the syringe transfer unit (5000).

For instance, as depicted in FIG. 20, the third gripping unit (3200″) may be positioned vertically above the syringe automation unit (2000), while the fourth gripping unit (3300″) is positioned laterally, forming a 90° with the third gripping unit relative to the syringe automation unit (2000).

Additionally, referring to FIG. 21(f), the fourth gripping unit (3300″) may be located such that forward movement of the syringe automation unit (2000) by the syringe transfer unit (5000) allows the syringe needle (A-1) to be inserted into the inlet of the injection container (e.g., an IV bag).

However, the present disclosure is not limited thereto. If the fourth gripping unit (3300″) is located such that the syringe needle (A-1) and the inlet of the injection container can be aligned by rotation of the syringe automation unit (2000), this arrangement also falls within the scope of the present disclosure.

The third and fourth gripping units (3200″, 3300″) may be configured similarly to the fourth gripping unit (3300) of the previously described embodiment, differing only in position.

For example, referring again to FIGS. 9 and 10, the third gripping unit (3200″) may be implemented as the second gripper (3200), designed to grip a vial using a toggle mechanism for open-close operation.

Similarly, referring to FIGS. 11 to 15, the fourth gripping unit (3300″) may include one or both of: a third gripper (3310) for cylindrical IV bag inlets and a fourth gripper (3320) for polyhedral inlets.

If both grippers are provided, they may be configured to operate simultaneously. Both may feature a toggle-type opening and closing mechanism.

Each gripper may also be equipped with gripper teeth (3311, 3321) on their gripping surfaces, spaced apart to support both the protrusion (C-2) of the IV bag and the pouch area. Additionally, an insertion groove (3323) may be formed to accommodate and support the protrusion.

In this embodiment, the syringe transfer unit (5000) is located between the housing (1000) and the syringe automation unit (2000), thereby supporting and actuating the syringe automation unit (2000) to rotate and move forward or backward. This enables the syringe to be positioned either at a third position (aligned with the extraction container held by the third gripping unit (3200″)) or a fourth position (aligned with the injection container held by the fourth gripping unit (3300″)).

To perform these functions, the syringe transfer unit (5000) may include: a rotational moving unit (5100) for rotating the syringe automation device (2000), and a linear moving unit (5200) for moving it forward and backward.

The linear moving unit (5200) may include a linear moving plate (5210) that supports the syringe automation unit (2000), and a linear driving unit (5220) provided on both sides to actuate forward and backward movement. The rotational moving unit (5100) may include a rotational plate (5110) supporting the linear driving unit (5220), and a rotational driving unit (5120) arranged along the periphery of the rotational plate (5110).

Referring to FIG. 21, an example operational sequence of the syringe transfer unit (5000) will now be described.

In the initial state, the syringe transfer unit (5000) may be positioned such that the needle (A-1) of the syringe inserted into the syringe automation unit (2000) is aligned to face the third gripping unit (3200″). At this stage, an extraction container may be held by the third gripping unit (3200″), and an injection container may be held by the fourth gripping unit (3300″) ((a) of FIG. 21).

Subsequently, the linear moving plate (5210) moves forward—i.e., in a direction toward the third gripping unit (3200″)—to bring the syringe into contact with the extraction container, thereby establishing a connection between the two ((b) of FIG. 21).

Next, the piston gripping unit (2200) of the syringe automation unit (2000) retracts the piston away from the third gripping unit (3200″) to extract the liquid medicine from the extraction container ((c) of FIG. 21).

Thereafter, the linear moving plate (5210) retracts—i.e., moves away from the third gripping unit (3200″)—to disengage the syringe from the extraction container ((d) of FIG. 21).

Following this, the rotational plate (5110) rotates to realign the syringe such that the needle (A-1) is oriented toward the fourth gripping unit (3300″) ((e) of FIG. 21).

The linear moving plate (5210) then moves forward again—i.e., toward the fourth gripping unit (3300″)—to bring the syringe into contact with the injection container, thereby establishing a connection for injection ((f) of FIG. 21).

Subsequently, the piston gripping unit (2200) pushes the piston toward the fourth gripping unit (3300″) to inject the extracted liquid medicine into the injection container, thereby completing the transfer process.

The foregoing description is provided for illustrative purposes only. It will be apparent to those skilled in the art that various modifications and alternative implementations can be made without departing from the technical spirit or essential features of the present disclosure. Accordingly, the embodiments described above should be considered exemplary and non-limiting in all respects.

For instance, although the present disclosure has been described with reference to the embodiments illustrated in the accompanying drawings, such embodiments are provided merely as examples. Those skilled in the art will appreciate that various modifications, substitutions, and variations are possible within the scope and spirit of the present disclosure.

Therefore, the true scope of legal protection of the present disclosure shall be defined by the appended claims, and all equivalents or modifications falling within the scope of the claims and their equivalents shall be interpreted as being encompassed within the scope of the present disclosure.

1. An automated liquid medicine transfer apparatus using a syringe, comprising:
a housing;
a syringe automation unit disposed on one side of the housing, comprising:
a barrel fixing unit that secures the barrel of an inserted syringe;
a piston gripping unit that grips the piston of the syringe; and
a syringe drive unit configured to move the barrel fixing unit and the piston gripping unit relative to each other;
a liquid medicine container transfer automation unit, comprising:
a first frame disposed at an upper portion of the housing;
a first gripping unit disposed on one side of the first frame and configured to grip an extraction container containing a liquid medicine to be extracted;
a second gripping unit disposed on the other side of the first frame and configured to grip an injection container into which the extracted liquid medicine is to be injected; and
a frame transfer unit configured to move the first frame between a first position where the extraction container and the syringe meet, and a second position where the injection container and the syringe meet; and
a control unit operably connected to the syringe drive unit and the frame transfer unit, the control unit being configured to:
pull the piston to extract the liquid medicine when the first frame is in the first position; and
push the piston to inject the liquid medicine when the first frame is in the second position.

2. The apparatus of claim 1, wherein the barrel fixing unit is configured such that the syringe is inserted and fixed with its needle oriented vertically upward.

3. The apparatus of claim 1, wherein the barrel fixing unit is configured to fix a handle portion of the syringe barrel.

4. The apparatus of claim 3, wherein the barrel fixing unit comprises:
a syringe handle support plate configured to support the lower surface of the syringe handle;
a syringe handle pressing plate disposed above the syringe handle support plate; and
a pressing plate drive unit configured to move the syringe handle pressing plate vertically;
wherein the syringe inserted between the support plate and the pressing plate is fixed in place.

5. The apparatus of claim 3, wherein the barrel fixing unit comprises:
a syringe handle support plate configured to support an upper surface of the syringe handle;
a syringe handle pressing plate disposed below the support plate; and
a pressing plate drive unit configured to move the syringe handle pressing plate vertically;
wherein the syringe inserted between the support plate and the pressing plate is fixed in place.

6. The apparatus of claim 1, wherein the barrel fixing unit further comprises:
a first gripper disposed above the syringe handle pressing plate and including a pair of first gripper arms symmetrically positioned and configured to perform an opening and closing operation by moving parallel to each other in opposite directions based on a predefined axis.

7. The apparatus of claim 6, wherein each of the first gripper arms extends in a direction parallel to the predefined axis.

8. The apparatus of claim 6, wherein each of the first gripper arms comprises: on a gripping surface,
a first inclined surface forming a first angle (θ) with respect to the gripper's parallel movement axis; and
a second inclined surface forming a second angle (−θ) with respect to the parallel movement axis;
wherein the first and second angles have equal magnitudes and opposite signs.

9. The apparatus of claim 6, wherein the gripping surface of each first gripper arm is curved to accommodate an outer surface of the syringe barrel.

10. The apparatus of claim 1, wherein the piston gripping unit comprises:
a first slot having a first width (W1); and
a second slot having a second width (W2) and is connected with an upper portion of the first slot;
wherein the piston handle gripping frame is configured to support upper and lower surfaces of a piston handle,
wherein W1 is greater than or equal to the width of the piston handle, and
wherein W2 is greater than or equal to the width of a piston rod and less than the width of the piston handle.

11. The apparatus of claim 10, wherein the piston gripping unit further comprises:
a pressing plate insertion hole passing through a bottom surface of the piston handle gripping frame and is connected with a lower side of the first slot;
a piston handle pressing plate positioned within the insertion hole; and
a pressing plate drive unit configured to move the pressing plate vertically.

12. The apparatus of claim 1, wherein the first gripping unit and the second gripping unit are configured to grip the extraction container and the injection container, respectively, with their openings oriented vertically downward.

13. The apparatus of claim 1, wherein the first gripping unit includes a second gripper configured to grip a medicine vial, and
the second gripping unit is selected from a group consisting of a third gripper configured to grip an intravenous bag with a cylindrical inlet, a fourth gripper configured to grip an intravenous bag with a polyhedral inlet, or a combination thereof.

14. The apparatus of claim 13, wherein the second to fourth grippers are configured to maintain an open or closed state using a toggle mechanism.

15. The apparatus of claim 13, wherein each of the third and fourth grippers includes at least one gripper tooth on gripping surfaces of respective gripper arms.

16. The apparatus of claim 15, wherein a plurality of gripper teeth is provided on the gripping surface of each gripper arm, and
wherein the plurality of gripper teeth is vertically spaced apart from one another.

17. The apparatus of claim 13, wherein each of the third and fourth grippers includes an insertion groove on a lower surface thereof, the insertion groove being configured to receive and support the protrusion of an inlet of the intravenous bag.

18. The apparatus of claim 1, wherein the frame transfer unit is configured to move in a two-axis orthogonal direction.

19. The apparatus of claim 1, wherein the first frame further comprises an intravenous bag holder configured to hold a pouch-type container.

20. The apparatus of claim 1, wherein the frame transfer unit is configured to move the first frame vertically and rotate the first frame about a vertical axis as the axis of rotation.

21.-22. (canceled)
